(19) United States
(12) Patent Application Publication
(10) Pub. No.: US 2021/0332959 A1
(43) Pub. Date: Oct. 28, 2021

(54) WALL LAMP WITH INTEGRAL HOOD-SHELL STRUCTURE

(71) Applicant: GUANGDONG OML TECHNOLOGY CO., LTD., Dongfeng Town Zhongshan City, Guangdong (CN)

(72) Inventor: Xiaobing LI, Dongfeng Town Zhongshan City, Guangdong (CN)

(73) Assignee: GUANGDONG OML TECHNOLOGY CO., LTD., Dongfeng Town Zhongshan City, Guangdong (CN)

(21) Appl. No.: 16/321,876

(22) PCT Filed: Dec. 28, 2018
(86) PCT No.: PCT/CN2018/124636

§ 371 Date: Jan. 30, 2019

(30) Foreign Application Priority Data
Dec. 13, 2018 (CN) 201822095830.3

(51) Int. Cl. F21S 8/00; F21V 23/00; F21V 3/00; F21V 17/16; F21V 31/00; F21V 29/70; F21V 17/12; F21V 21/088

(52) U.S. Cl. CPC F21S 8/033; F21V 23/009; F21V 3/00; F21V 17/16; F21V 21/088; F21V 29/70; F21V 23/002; F21V 17/12; F21V 31/005

(57) ABSTRACT

A wall-mounted lamp with an integral hood-shell structure comprises a rear shell and a front shell. A drive control module and a light source module are provided between the rear shell and the front shell. The front shell includes a light-transmitting hood and a light-shading hood which are connected to each other and are of an integral structure. In the disclosure, the light-transmitting hood and the light-shading hood of the front shell are of an integral structure, and the front shell can be mounted on the front shell as a whole, without any waterproof structure provided between the light-shading hood and the light-transmitting hood.

### CROSS-REFERENCE TO RELATED APPLICATIONS

This application is a national phase application of International Application No. PCT/CN2018/124636, filed Dec. 28, 2018, which claims priority to CN 201822095830.3 filed Dec. 13, 2018, all of which are hereby incorporated herein by reference.

### FIELD OF THE INVENTION

The present disclosure relates to LED lamps and in particular to a wall-mounted lamp.

### BACKGROUND OF THE INVENTION

A wall lamp is a lamp hung on the wall, which can be used for illumination and decoration. The wall lamp is more and more widely mounted in some places such as homes. A front shell of an existing wall-mounted lamp includes two portions, i.e., a light-shading hood and a light-transmitting hood, which are of a split structure. Thus, the light-shading hood and the light-transmitting hood will be separately mounted on the rear shell of the wall-mounted lamp. Consequently, the assembly process of the wall-mounted lamp is tedious, resulting in low efficiency of production. In addition, since the light-shading hood and the light-transmitting hood are of a split structure, there is a joint seam between the light-shading hood and the light-transmitting hood, so that a waterproof structure needs to be specially provided between the light-shading hood and the light-transmitting hood. If a waterproof rubber strip is used, the waterproof rubber strip will be designed to be curved, so that the waterproof effect is poor and it is inconvenient to mount. If glue is applied between the light-shading hood and the light-transmitting hood, the assembly process of the wall-mounted lamp is also tedious, resulting in low efficiency of production.

### SUMMARY OF THE INVENTION

The disclosure provides a wall-mounted lamp with an integral hood-shell structure to solve the problem of tedious assembly process of the wall-mounted lamp.

To solve the technical problem, the following technical solutions are provided.

A wall-mounted lamp with an integral hood-shell structure includes a front shell and a front shell, wherein a drive control device and a light source module is provided between the rear shell and the front shell, and wherein the front shell including a light-transmitting hood and a light-shading hood that are connected to each other and are of an integral structure.

In an embodiment, a first clamping groove is formed on one of the light-transmitting hood and the light-shading hood, and a first clamping strip extending into the first clamping groove is provided on the other one of the light-transmitting hood and the light-shading hood.

In an embodiment, at least one second clamping groove is formed on one of the light-transmitting hood and the light-shading hood, and a second clamping strip extending into the second clamping groove is provided on the other one of the light-transmitting hood and the light-shading hood.

In an embodiment, a light-transmitting portion is provided on the light-shading hood, at least one third clamping groove is formed on one of the light-transmitting portion and the light-shading hood, and a third clamping strip extending into the third clamping groove is provided on the other one of the light-transmitting portion and the light-shading hood.

In an embodiment, convex stripes or concave stripes are formed on an inner wall of the light-transmitting hood.

In an embodiment, a sealing rubber strip is cushioned between the front shell and the rear shell.

In an embodiment, a slope is provided on the rear shell, and the light source module is mounted on the slope such that the light source module is oriented obliquely downward.

In an embodiment, a heat dissipation groove extending into the slope is formed on the rear shell.

In an embodiment, a lead sealing structure is further provided between the rear shell and the front shell; the lead sealing structure comprises a mounting block and a power wire harness disposed on the mounting block; the power wire harness passes through the rear shell to be electrically connected to the drive control device; the mounting block is connected to the rear shell through a first threaded fastener; and, a sealing ring is cushioned between the mounting block and the rear shell.

In an embodiment, a mounting frame is further provided on the rear shell; the mounting frame includes a mounting plate and a wall frame; the mounting plate is connected to the rear shell; a hanging groove is formed on one of the mounting plate and the wall frame, and a hanging lug is provided on the other one of the mounting plate and the wall frame; and, the hanging lug is inserted into the hanging groove to hang the mounting plate and the wall frame together.

The disclosure has the following beneficial effects. In the disclosure, the light-transmitting hood and the light-shading hood of the front shell are of an integral structure, and the front shell can be mounted on the front shell as a whole, without any waterproof structure provided between the light-shading hood and the light-transmitting hood. Accordingly, the mounting operation of the front shell can be simplified, the assembly procedures of the wall-mounted lamp can be reduced, and the production efficiency can be improved.

### BRIEF DESCRIPTION OF THE DRAWINGS

The disclosure will be further described below by embodiments with reference to the accompanying drawings.

FIG. 1 is a schematic structural diagram of the disclosure;

FIG. 2 is an exploded view of the disclosure;

FIG. 3 is a sectional view of the disclosure after a mounting frame is removed;

FIG. 4 is an exploded view of a first implementation of a front shell;

FIG. 5 is a schematic structural diagram of a rear shell;

FIG. 6 is a schematic structural diagram of the mounting frame; and

FIG. 7 is an exploded view of a second implementation of the front shell.

### DETAILED DESCRIPTION OF THE EMBODIMENTS

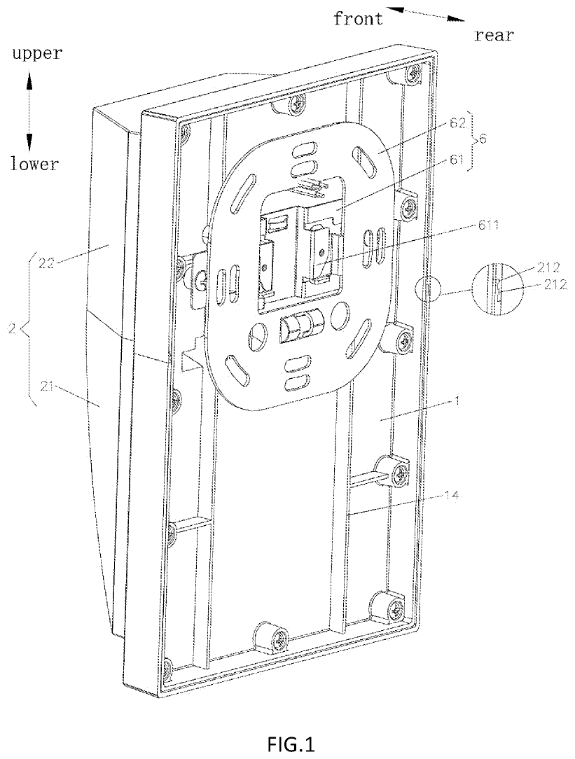

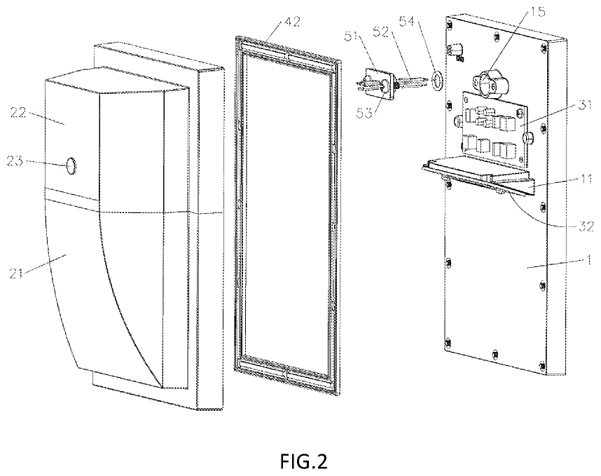

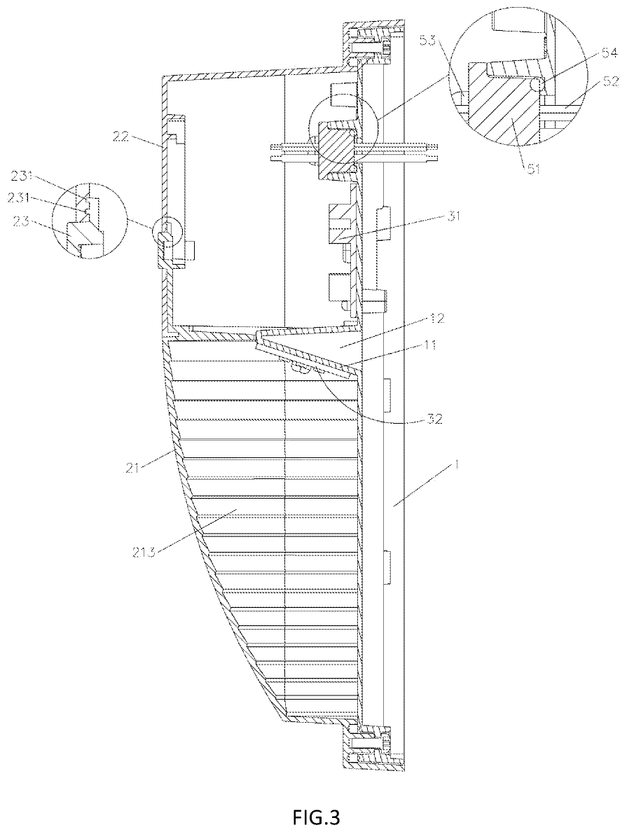

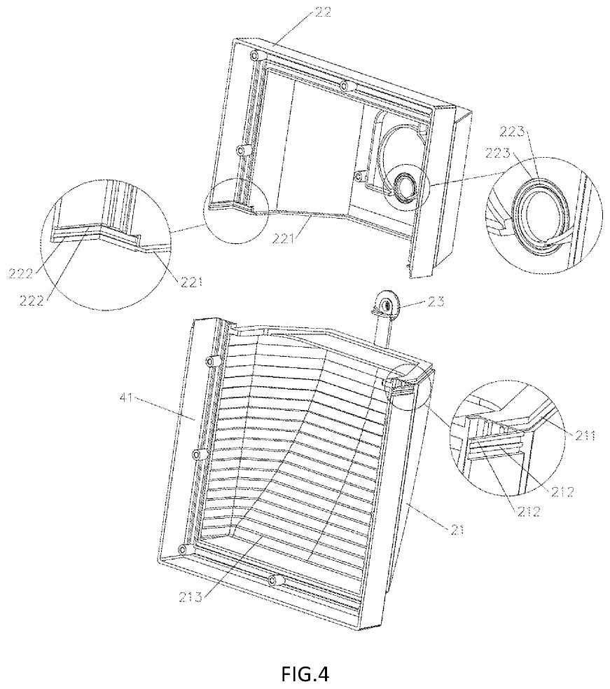

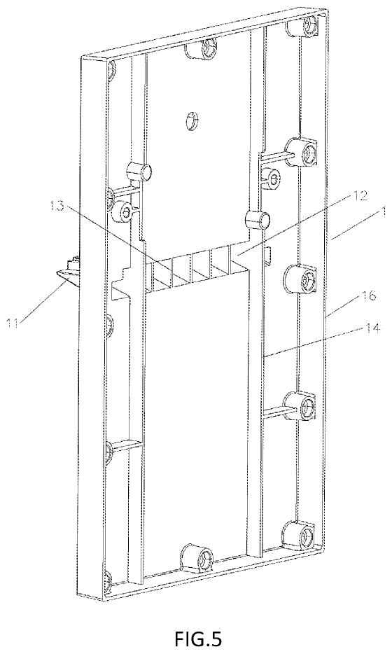

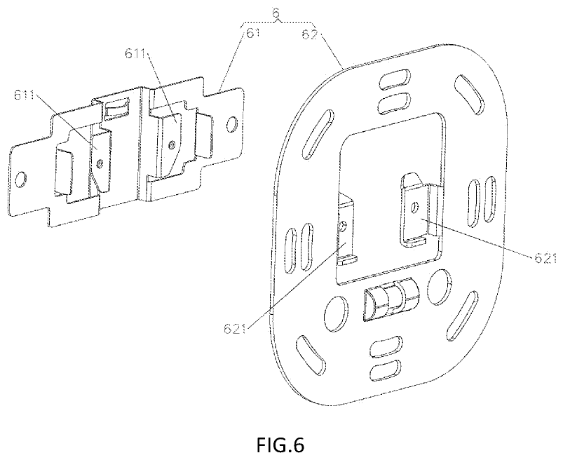

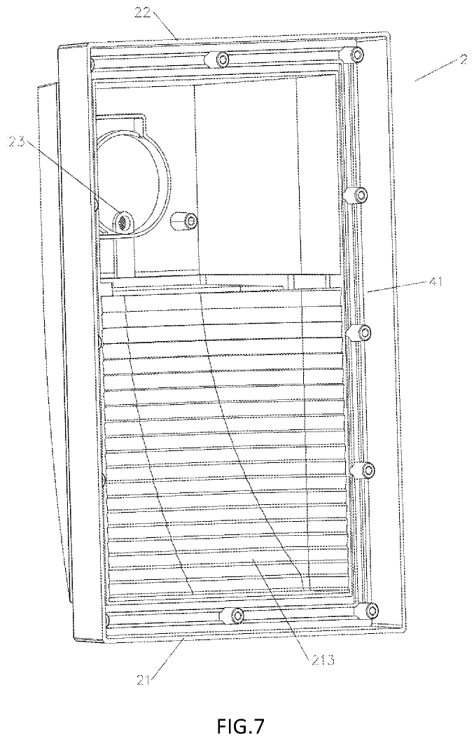

Referring to FIGS. 1-7, the disclosure provides a wall-mounted lamp with an integral hood-shell structure, including a rear shell 1 and a front shell 2. A drive control module 31 and a light source module 32 are provided between the rear shell 1 and the front shell 2. The front shell 2 includes a light-transmitting hood 21 and a light-shading hood 22 that are connected to each other and of an integral structure. The front shell 2 can be mounted on the rear front 1 as a whole, and no waterproof structure needs to be provided between the light-shading hood 22 and the light-transmitting hood 21. Accordingly, the mounting operation of the front shell 2 can be simplified, the assembly process of the wall-mounted lamp can be reduced, the time for assembly and production of the wall-mounted lamp can be saved, and it is advantageous for the waterproof design of the wall-mounted lamp and the optimization of waterproof effect.

In the first embodiment of the front shell 2, the front shell 2 is formed by two times of injection molding, i.e., one of the light-transmitting hood 21 and the light-shading hood 22 is formed by the first injection molding, and the other hood is then placed in another injection mold, and the second injection molding is performed to form the front shell 2, so that the light-transmitting hood 21 and the light-shading hood 22 are of an integral structure.

A first clamping groove 211 is formed on one of the light-transmitting hood 21 and the light-shading hood 22, and a first clamping strip 221 extending into the first clamping groove 211 is provided on the other one of the light-transmitting hood 21 and the light-shading hood 22. In this way, the front shell 2 can be seamlessly formed, and the connection between the light-transmitting hood 21 and the light-shading hood 22 can be more stable, so that it is advantageous for the waterproofness of products.

Further, at least one second clamping groove 222 is formed on one of the light-transmitting hood 21 and the light-shading hood 22, and a second clamping strip 212 extending into the second clamping groove 222 is provided on the other one of the light-transmitting hood 21 and the light-shading hood 22. In an embodiment, as shown, two clamping grooves 222 and two clamping strips 212 are provided on any one side of the front shell 2, so that the connection between the light-transmitting hood 21 and the light-shading hood 22 is more stable.

A light-transmitting portion 23 connected to the light-transmitting hood 21 is provided on the light-transmitting hood 22, and at least one third clamping groove 223 is formed on one of the light-transmitting portion 23 and the light-shading hood 22, so that the stability of connection between the light-transmitting portion 23 and the light-shading hood 23 is improved and it is advantageous for the waterproofness of products. A photosensitive element is mounted at a position corresponding to the light-transmitting portion 23. The photosensitive element is electrically connected to the drive control device 31 to realize the light sensitivity control of the disclosure. In an embodiment, as shown, there are two third clamping grooves 223 and third clamping strips 231, so that the stability of connection between the light-transmitting portion 23 and the light-shading hood 22 is further improved and it is advantageous for the waterproofness of products.

In the second embodiment of the front shell 2, the front shell 2 is formed by double-shot molding, so that the light-transmitting hood 21 and the light-shading hood 22 are of an integral structure. The front shell 2 of an integral structure can also be formed by once injection molding and then coating a light-shading layer.

Convex stripes 213 or concave stripes are formed on an inner wall of the light-transmitting hood 21 to scatter light, so that the light transmitting through the light-transmitting hood 21 is uniform and gentle, avoiding dizziness. Specifically, the cross section of the convex stripes is serrated or wavy.

A side edge of the front shell 2 is extended backward to form a mounting groove 41 and the rear shell 1 is inserted into the mounting groove 41, so it is convenient for the positioning of the rear shell 1 and the front shell 2; moreover, a waterproof sealing surface can be formed between a sidewall of the mounting groove 41 and a sidewall of the front shell 2 in order to avoid water entrance.

A sealing rubber strip 42 is cushioned between the front shell 2 and the front shell 1. In an embodiment, the sealing rubber strip 42 is disposed in the mounting groove 41. Since no waterproof structure needs to be provided between the light-shading hood 22 and the light-transmitting hood 21, the sealing rubber strip 42 can be designed to be linear, so that the structure is simple and better waterproof effect is realized.

A slope 11 is provided on the rear shell 1, and the light source module 32 is mounted on the slope 11 such that the light source module 32 is oriented obliquely downward. Accordingly, light can be projected onto the inner wall of the light-transmitting hood 21 within a larger range, and it is advantageous for light scattering. The drive control device 31 is also mounted close to the rear shell 1, so that the heat can be conducted by the rear shell 1 and it is advantageous for the heat dissipation of the drive control device 31.

A heat dissipation groove 12 extending into the slope 11 is formed on the rear front 1. When the wall-mounted lamp emits light, the heat on the light source module 32 is conducted to the air in the heat dissipation groove 12 through the slope 11 and then dissipated to the outside, so that it is advantageous for the heat dissipation of the wall-mounted lamp, the service life is prolonged, and the safety can be improved.

A first reinforcing rib 13 is provided in the heat dissipation groove 12 in order to improve the structural strength of the rear shell 1. The first reinforcing rib 13 can also conduct heat and thus facilitate the heat dissipation. In addition, a second reinforcing rib 14 is further provided on the rear shell 1 in order to further improve the structural strength of the rear shell 1. A rim 16 extending backward is provided on a side edge of the rear shell 1 to form an accommodating groove on the rear shell 1. When the wall-mounted lamp is mounted on a wall surface, an air isolation cavity can be formed between the rear shell 1 and the wall surface, so that it is advantageous for the dissipation of heat from the wall-mounted lamp. The rim 16 can also improve the structural strength of the rear shell 1.

A lead sealing structure is further provided between the rear shell 1 and the front shell 2. The lead sealing structure includes a mounting block 51 and a power wire harness 52 disposed on the mounting block 51. The power wire harness 52 passes through the rear shell 1 to be electrically connected to the drive control device 31. The mounting block 51 is connected to the rear shell 1 through a first threaded fastener 53, and a sealing ring 54 is cushioned between the mounting block 51 and the rear shell 1, so as to improve the sealing performance of the mounting block 51 and the rear shell 1 and avoid water entrance. Since the sealing is not realized by gluing, it is convenient to assemble the wall-mounted lamp. In an embodiment, a groove 15 is formed on the rear shell 1, the mounting block 51 is inserted into the groove, and the sealing ring 54 is also located in the groove 15, so that it is convenient for mounting and positioning the mounting block 51 and the sealing ring 54, thus avoiding the sliding and dislocation of the sealing ring 54.

In addition, a mounting frame 6 is further provided in the front shell 1, which includes a mounting plate 61 connected to the front shell 1, and a wall frame 62. A hanging groove 621 is formed on one of the mounting plate 61 and the wall frame 62; and a hanging lug 611 is provided on the other one of the mounting plate 61 and the wall frame 62. The hanging lug 611 is inserted into the hanging groove 621 to hang the mounting plate 61 and the wall frame 62 together. During mounting the wall-mounted lamp, the wall frame 62 is mounted on a wall surface or a wiring box, and the mounting plate 61 is hung on the wall frame 62, so that the wall-mounted lamp is hung. The mounting operation of the wall-mounted lamp is convenient. The mounting frame 6 is located in the accommodating groove. In the presence of the rim 16, when the wall-mounted lamp is mounted on the wall surface, the rim 16 can be fitted with the wall surface and shelters the mounting frame 6, so that the wall-mounted lamp is beautiful in appearance.

In the description of the disclosure, the orientation or position relation indicated by terms “upper”, “lower”, “front”, “rear” or the like is an orientation or position relation shown by the accompanying drawings, merely for describing the disclosure and simplifying the description rather than indicating or implying that the specified device or element must have a particular orientation or be constructed and operated in a particular orientation. Therefore, the terms should not be interpreted as limitations to the disclosure.

The embodiments described above are preferred solutions of the present disclosure, and other implementations of the present disclosure are also possible. The technical features in different embodiments can also be combined as long as the combination can be realized. Equivalent modifications or substitutions can be made by those skilled in the art without departing from the principle of the present disclosure, and these equivalent modifications or substitutions shall fall into the scope defined by the claims of the present application.

1. A wall-mounted lamp with an integral hood-shell structure, comprising a front shell and a front shell, a drive control device and a light source module being provided between the rear shell and the front shell, the front shell comprising a light-transmitting hood and a light-shading hood, wherein the light-transmitting hood and the light-shading hood are connected to each other and of an integral structure.

2. The wall-mounted lamp according to claim 1, wherein a first clamping groove is formed on one of the light-transmitting hood and the light-shading hood, and a first clamping strip extending into the first clamping groove is provided on the other one of the light-transmitting hood and the light-shading hood.

3. The wall-mounted lamp according to claim 1, wherein at least one second clamping groove is formed on one of the light-transmitting hood and the light-shading hood, and a second clamping strip extending into the second clamping groove is provided on the other one of the light-transmitting hood and the light-shading hood.

4. The wall-mounted lamp according to claim 1, wherein light-transmitting portion is provided on the light-shading hood, at least one third clamping groove is formed on one of the light-transmitting portion and the light-shading hood, and a third clamping strip extending into the third clamping groove is provided on the other one of the light-transmitting portion and the light-shading hood.

5. The wall-mounted lamp according to claim 1, wherein convex stripes or concave stripes are formed on an inner wall of the light-transmitting hood.

6. The wall-mounted lamp with an integral hood-shell structure according to claim 1, wherein a sealing rubber strip is cushioned between the front shell and the rear shell.

7. The wall-mounted lamp according to claim 1, wherein a slope is provided on the rear shell, and the light source module is mounted on the slope such that the light source module is oriented obliquely downward.

8. The wall-mounted lamp with an integral hood-shell structure according to claim 7, wherein a heat dissipation groove extending into the slope is formed on the rear shell.

9. The wall-mounted lamp according to claim 1, wherein: a lead sealing structure is further provided between the rear shell and the front shell; the lead sealing structure comprises a mounting block and a power wire harness disposed on the mounting block; the power wire harness passes through the rear shell to be electrically connected to the drive control device the mounting block is connected to the rear shell through a first threaded fastener and, a sealing ring is cushioned between the mounting block and the rear shell.

10. The wall-mounted lamp according to claim 1, wherein a mounting frame is further provided on the rear shell; the mounting frame comprises a mounting plate and a wall frame; the mounting plate is connected to the rear shell; a hanging groove is formed on one of the mounting plate and the wall frame, and a hanging lug is provided on the other one of the mounting plate and the wall frame; and, the hanging lug is inserted into the hanging groove to hang the mounting plate and the wall frame together.

11. The wall-mounted lamp according to claim 2, wherein at least one second clamping groove is formed on one of the light-transmitting hood and the light-shading hood, and a second clamping strip extending into the second clamping groove is provided on the other one of the light-transmitting hood and the light-shading hood.
